(19) United States
(12) Patent Application Publication
(10) Pub. No.: US 2011/0079747 A1
(43) Pub. Date: Apr. 7, 2011

(54) Direct current simplex generator

(76) Inventor: Edward Milton McWhorter, Citrus Heights, CA (US)

(21) Appl. No.: 12/587,102

(22) Filed: Oct. 2, 2009

(51) Int. Cl. H01G 9/035; C22C 24/00

(52) U.S. Cl. 252/62.2; 420/400

(57) ABSTRACT

A method of generating an electric current by accurately dispensing a finite equal quantity of fluidized alkaline metals at equally spaced intervals into an injector water spray for subsequent reaction in live steam in a reaction chamber releasing electrons for an ionic capacitor of a capacitor tuyere.

### CROSS REFERENCES

The invention presented is preceded by the following U.S. Patents and co-pending U.S. Applications.

Ref. 1 U.S. patent application Ser. No. 12/055,093 filed Dec. 26, 2007 Potassium Electric Generator and Chemical Synthesizer.
Ref. 2 U.S. Pat. No. 6,653,007 Hydrogen Generator.
Ref. 3 U.S. Pat. No. 7,288,335 Alkaline Electrode Tape.
Ref. 4 U.S. Pat. No. 6,831,825 Fuel Cell Ionic Capacitor.
Ref. 5 U.S. Pat. No. 7,381,378B2 Coal Flue Gas Scrubber

### BACKGROUND OF THE INVENTION

An electrical current is generated at discrete intervals to produce intense individual pulses of direct current electron flow that is released during the cyclic hydrolysis of small quantities of fluidized alkaline metals, Li, Na, K, and with mixtures of alkaline earth metals, Ca and Mg, in a reaction chamber. The mechanism used for dispensing the said alkaline metals into the said reaction chamber producing individual segmented flowing quantities of the said fluidized alkaline metals at evenly spaced and controlled intervals is hereinafter termed a simplex generator. When the said simplex generator produces overlapping pulses, as those described in Ref. 1, it is termed a multiplex generator to be used principally for chemical synthesis.

Simplex generators are best used in direct current electrical generation for transformer operation, a task most generally reserved for alternating current (ac) circuits. Simplex generators used in conjunction with an injector create large surging pulses of free electrons which produce strong magnetic field forces across the secondary windings of a transformer. Pulsing direct current transformers are more efficient than alternating current transformers because the current flow is only in one direction such that hysteresis losses are low because the transformer iron core magnetic field reversal does not occur and therefore does not inhibit the capacitor tuyere die-away factor continued current flow that is described in Ref. 1.

Multiplex generator transformer operation is less effective than simplex generator transformer operation because the amplitude of the current pulse generated is lower. The said simplex generator system current slope is much more pronounced than the said multiplex generator compared at the same cycle rate. At the said higher slope amplitude the magnetic flux generated by the primary core winding must cut across the conductor of the secondary coil at a higher rate generating a higher current transfer.

Multiplex generators are best suited for the rupture of carbon dioxide double bonds to produce calcium cyanamide or the formation of dicarboxyillic acids for use in organic synthesis.

The said current flow that is generated by the simplex generator is the result of the shearing action of the bonds of the water molecule by reaction with an alkaline metal in a reaction chamber releasing the bonding electrons which hold the hydrogen atom to the oxygen atom. In the sodium hydrolysis one negative charged electron, and one positively charged proton, and a sodium hydroxyl ion are produced (Na+H₂O→NaOH+H⁺+e⁻). Because the reactions of the alkaline earth metals of Group II (Mg, Ca) are slower reacting during hydrolysis than the alkaline metals of Group I (Li, Na, K) mixtures of the two Groups are formulated as described in Ref. 2.

The method of accurately dispensing small measured quantities of Group I and Group II metals for hydrolysis at equally spaced intervals in a cathode electrolyte proposed in Ref. 2 was to seal the reactants between two tapes. A pin roller was used to puncture the tape while it was submerged beneath the cathode electrolyte exposed the alkaline metal substances for hydrolysis. The design was improved in Ref. 3 Patent by the use of a perforated tape and a stripper tape to expose the metals for hydrolysis in the cathode electrolyte in later designs. Electrons released in the cathode electrolyte were then conducted to the anode electrolyte by an ionic capacitor described in Ref. 4 which in the current design is termed the capacitor tuyere of Ref. 1.

In the present invention larger quantities of reactant alkaline metals are required for higher current loads. The said tape dispensing methods are replaced by a rotating shaft orifice which opens and closes the flow of fluidized mixtures of alkaline metals 60 times a minute (60 hz) releasing the metals for injection into a hydrolyzing reaction chamber. The reacted ionized stream is then released into the capacitor tuyere of Ref 1 where it is converted into a 60 hz pulsing direct current used for electrical direct current transformer operation.

Machine screws and threaded bolt fasteners are simple design features common to most mechanical construction just as rectilinear reciprocating movement of pintle rods controlling the up and down motion of plug valves or threaded mechanism for raising and lowering of gate valves, or the rotation of spindle shaft petcock valving, are also established design features of flowing processes and are of themselves no longer qualified as novel. The novel feature of the present invention described is the integrated assembly of prefabricated machine process elements used for the cyclic alkaline metal valving process for the delivery of controlled quantities fluidized alkaline metals into an injector passing subsequently into a hydrolyzation reaction chamber to produce an uninterrupted series of electron pulses into a capacitor tuyere. The said capacitor tuyere receives and collects the 60 hz pulsing surge current for use in an electrical transformer primary winding induction circuit to produce an induced current flow in the secondary winding of said transformer. A novel feature of the invention is the spindle shaft petcock valving system shaft which is made to rotate in the same direction at 30 rpm opening and closing the flow to the injector at a cyclic rate of 60 hz. Operation in this manner controls the distribution of finite quantities of fluidized metal for the production of electron flow at 60 hz pulses.

High pressure water introduced into the said injector and condensed live steam passing into the reaction chamber is collected at the said capacitor tuyere exit as a value added product to be subsequently used as an ejector liquid spray in Ref. 5 Coal Flue Gas Scrubber. The said tuyere water is rich in positive open bond material which increases retention of CO₂ during the scrubbing operation. The increased retention results from improved colligative properties of ejector spray water which strengthens the hydrogen to hydrogen bond between water molecules in the Capture matrix.

There are three general methods used in the dissociation of the water molecule, electrolysis, thermal dissociation, and by chemical reaction with reduced alkaline metals. All three said methods are present in the simplex electrolytic flow circuits of the invention. Chemical reaction begins at the injector. After thermal dissociation the retention of ion charge passing into the capacitor tuyere is enhanced by live steam from boiler system fire wall cooling circuit which is passed into the reaction chamber and electrolytic dissociation continues and is maintained in the capacitor tuyere circuits.

### SUMMARY OF THE INVENTION

It is the objective of the invention to provide a novel means of dispensing fluidized alkaline metals into a hydrolyzation reaction chamber to generate electrons by the rupture of hydrogen bonds to the oxygen atom of the water molecule.

It is another object of the invention to increase the acceleration of the rising slope of the amplitude curve of generated electrons to a spike in order to quicken the rate of the induced magnetic flux field cutting across the primary winding of an electrical transformer increasing the efficiency of the induction into the secondary winding of the said transformer.

In overall intent it is the object of this invention to demonstrate the use of fluidized alkaline metal technology in its developing dominant role in electron production for electrical generation for mobile and field stationary systems and the appended usage of the expended electrolyte as a value added product when used as a photo steriochemical tool in chemical synthesis and in carbon capture at coal-fired facilities.

### BRIEF DESCRIPTION OF THE DRAWINGS

Four drawings are presented to describe the working mechanics of the invention and the theory of operation in an expanding technical field of new methods of electrical generation.

FIG. 1 is a diagrammatic sketch of the two major mechanical working elements of of the simplex generator shown partially in cross-section.

FIG. 2 is a graphic presentation of generated pulsed direct current spike and subsequent die-away dissipation flow.

FIG. 3 is a box diagram of the system flow of simplex generators designated by a broken line boundary separating it from the comparative Ref. 1 multiplex generator systems.

FIG. 4 is a detail drawing of the six major mechanical assemblies of the simplex generator process equipment which operates in unison.

### DETAILED DESCRIPTION OF THE INVENTION

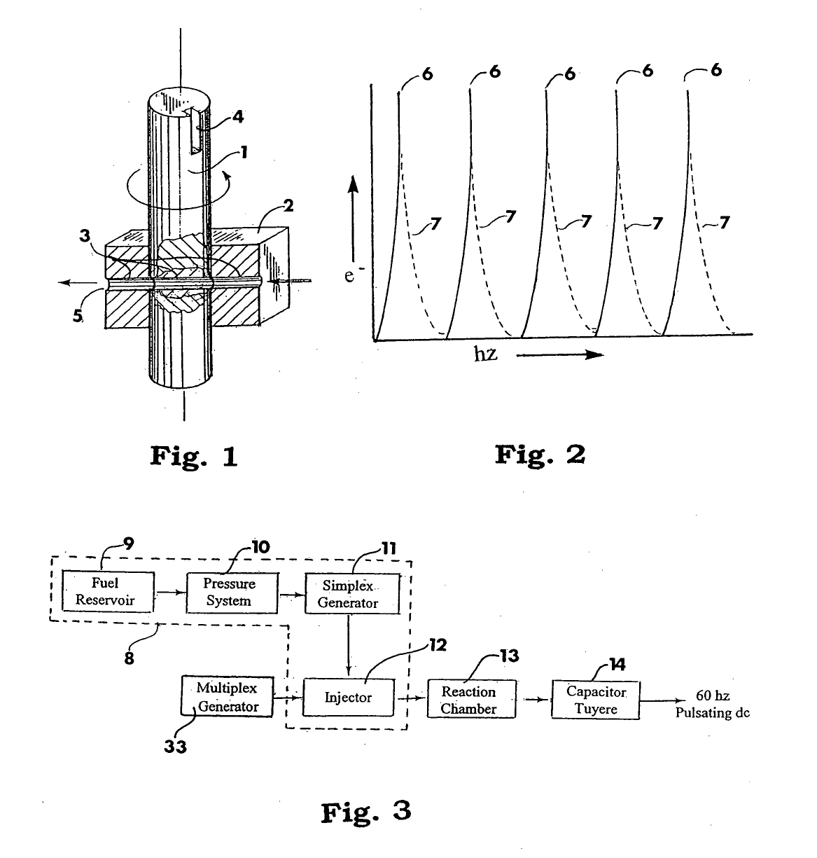

The principal mechanical embodiments of the invention are presented in FIG. 1 comprising a spindle shaft 1 rotatively mounted in block 2. An aligned passage 3 passes through said block 2 and said spindle shaft 1. When spindle shaft 1 is rotated at 30 rpm by a motor driven gear fixedly mounted on spindle shaft 1 by an assembly key inserted in slot 4 of spindle shaft 1 the flow through passage 3 is opened and closed sixty times per minute producing a 60 hz pulsing flow through passage 3 to outlet 5. The media flowing through passage 3 is hereinafter characterized as finite quantities of equally spaced fluidized alkaline metals which pass in 60 hz pulses from outlet 5 of block 2 into injector 12 graphically represented in box flow diagram in FIG. 3. When shaft 1, rotatively mounted in block 2, is assembled with gearing and caused to rotate by an electric motor it is hereinafter termed a simplex generator 11 graphically represented in box diagram in FIG. 3. When the said simplex generator 11 is assembled on injector 12 the composite assembly is hereinafter termed a simplex injector system.

Referring now to FIG. 2 which is a graph of finite increments of electron (e⁻) spiked curve 6 production (Qo initial charge) during hydrolysis of a fluidized alkaline metal and the intermediate interval of associated capacitor die-away (ε^{-bt}) residual current flow 7 (Qt charge at time t) shown in broken-line in capacitor tuyere 14 of FIG. 3 such that Qₜ=Q_{oε}^{-bt} where b is a constant decrement leaking out of capacitors 16.

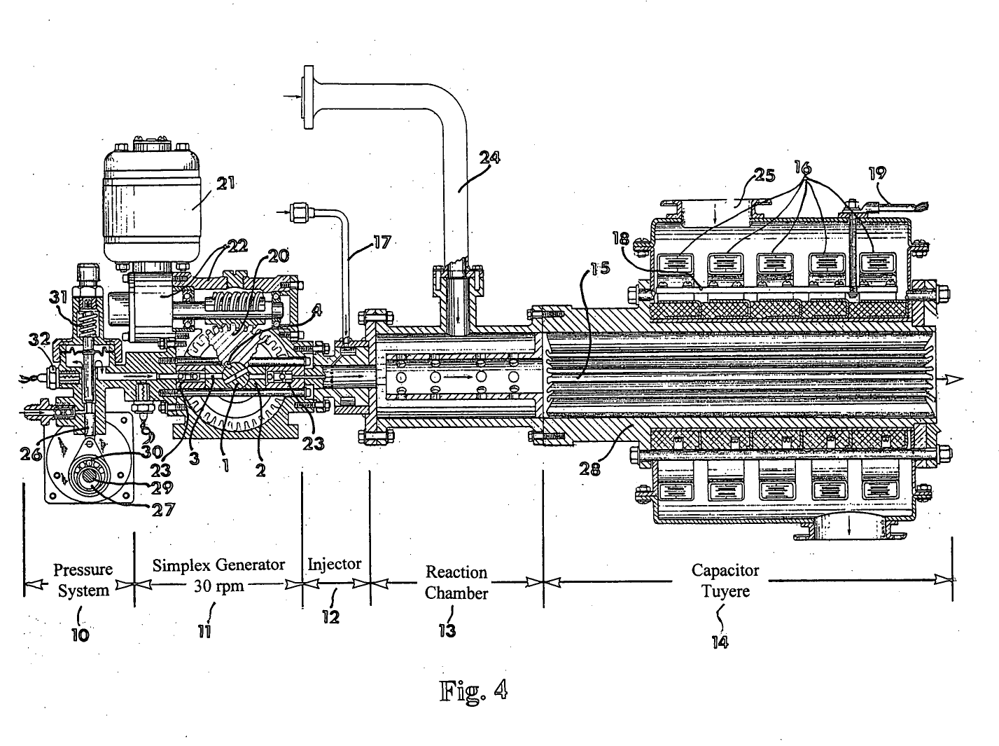

Turning now to FIG. 3 which is a box flow diagram of both the simplex generator of the present system and the multiplex generator of Ref. 1. The said simplex generator which comprises the novel features of the present invention is shown as being contained within the broken-line boundary 8. Fluidized metal from fuel reservoir 9 is pumped to pressure system 10. Pressure system 10 is a low volume high pressure positive displacement pump which forces the said fluidized metal into the aligned passage 3 of simplex generator 11. The simplex generator 11, during each revolution of shaft 1 opening and closing aligned passage 3, divides the flow through passage 3 into individual finite equal quantities of singular pulsed flow into injector 12 where it is sprayed with water and passed into live-steam in reaction chamber 13. The electrons within the gaseous ionic charge flow from reaction chamber 13′ passing into capacitor tuyere 14 where the electrons are captured on strakes 15 and pass into a plurality of toroidal shape capacitors 16 positioned circumferentially about capacitor tuyere 14 chamber 28 forming a capacitor electron storage bank. The said capacitor 16 storage bank of capacitor bank 16 of FIG. 4 producing the electron spikes 6 and capacitor die-away current flow 7 indicated in FIG. 2.

A more detailed description of the simplex generator process flow is presented in FIG. 4. The pulsating flow of alkaline metals from simplex generator 11 passes into injector 12 through a high pressure water spray 17 and passes in 60 hz surging pressure spurts into live steam entering reaction chamber 13 from steam conduit 17. The hydrolyzation of the fluidized alkaline metals from simplex generator 11 ruptures the hydrogen to oxygen bond of the water molecule producing charged ions and free electrons. The said free electrons are electro-statically captured by strakes 15 positioned around chamber 28 of capacitor tuyere 14, said strakes being in electrical communication with a plurality of toroidal capacitors 16 connect in parallel with an electrical bus-bar 18 connected to a load transmission cable 19. The said free electrons captured by the toroidal capacitors 16 pass through the load transmission cable 19 and are released to the primary winding of an electrical transformer. The said electrons from load cable 19 pass through the said primary winding as a 60 hz oscillating direct current having a cyclic amplitude 6 shown in FIG. 2 corresponding to the electrochemical equivalent flow volume mass of the fluidized alkaline metals passing into injector 12 from simplex generator 11.

Referring momentarily to FIG. 3. The pulsating flow of alkaline metals from simplex generator 11 passes into injector 12 through a high pressure water spray 17 and is pressurized by the reaction in 60 hz surging spurts into live steam 24 shown in FIG. 4 flowing into reaction chamber 13. The said injected alkaline metal is completely hydrolyzed in said reaction chamber 13. The said hydrolyzation ruptures the hydrogen bonds to the oxygen atom of the water molecule producing charged ions and free electrons. The said free electrons are electro-statically captured by capacitors 16 of tuyere 14 as shown in FIG. 4. The said free electrons captured by the capacitors 16 of tuyere 14 are released to the primary winding of an electrical transformer. The said electrons pass through the said primary winding as 60 hz pulsating direct current having an amplitude corresponding in electrochemical equivalents with the cyclic release in discrete volumetric flow pulses of alkaline metals passing into injector 12 from simplex generator 11.

Returning to FIG. 1. The sixty cycle opening and closing cycle flow events being formed in aligned passage 3 as a result of the 30 rpm rotation of shaft 1 produces a constantly varying flow volume of alkaline metals resulting in a quantitatively changing weight flow from outlet 5 to the injector as the alignment of passage 3 in block 2 changes with the alignment of passage 3 in spindle shaft 1 as it rotates in block 2. The velocity of flow to outlet 5 also changes proportionately in non-compressible continuity with the changing flow area of passage 3 through spindle shaft 1 to outlet 5 during transition from opening and closing of passage 3. Each opening event of channel 3 is separated by a much longer closed interval allowing sufficient time for complete hydrolyzation reaction of the alkaline metals injected into reaction chamber 13. The hydrolyzation reactions of the said alkaline metals injected into reaction chamber 13 produce electrons, a large portion of which are absorbed by the capacitor circuits of capacitor tuyere 14 of Ref. 1 shown immediately downstream of reaction chamber 8 in FIG. 3.

Turning now to FIG. 2. High intensity 60 hz electrical pulses are produced at discrete intervals by the cyclic hydrolyzation of individually separated small quantities of alkaline metals injected into reaction chamber 13. In accordance with the conservation of energy as stated in the First Law of Thermodynamics the electro-equivalent current flow of electrons produced in the hydrolyzation of the injected alkaline metal in reaction chamber 13 is the same amount required during the electrolysis process that were required to reduce the alkaline metals to their pure state. The electrons released during the hydrolysis in reaction chamber 13 are depicted in FIG. 2 as a series of steep spikes 6, which fall quickly downward as a residual current flow 7 of the die-away retention of the capacitor banks 16 of the capacitor tuyere 14 of Ref. 1. The said die-away current 7 of the capacitor tuyere 14 also provide a continuity of flow between each current spike 6 and this residual flow is depicted as a broken line connecting electron flow between spikes. The closed cycle period electron flow 7 is maintained by the said die-current flow above the initial injection beginning flow.

The novel features of the invention claimed are predominantly in the mechanical components of the simplex generator 11 shown in FIG. 4. Spindle shaft 1 rotatively mounted in block 2 is aligned with the bored passage 3 such that the said passage 3 is aligned with the bored passage 3 through spindle shaft 1. The said rotatively mounted shaft 1 is fixedly attached to gear 20 by inserting a key into key slot 4. Gear 20 is made to turn by gear motor 21 which operates through two 90° aligned reduction gearing sets 22. Check valves 23 are positioned at the inlet and outlet 5 of aligned passage 3 in block 2.

Piston 26 of the pressure system 10 pump of FIG. 4 is made to vertically reciprocate upward by eccentric cam 27 mounted on roller bearings on motor shaft 29. Said cam 27 mounted within non-filling notch bearing 30. Under high compression the ball bearing working within the non-filling notch is levered by inclined plane between bearings on both sides into circular alignment with its associate bearings. Piston 26 is made to move downward by spring 31 at which time the said notch bearing returns to its notched position causing piston 26 to drop to its BDC position. A plurality of electric heaters 32 are used to keep the pump structure, which acts as a heat sink, above the freezing point of the fluidized metals.

### NUMBERED ELEMENTS OF THE INVENTION

1. Spindle shaft
2. Block
3. Aligned passage
4. Key slot
5. Outlet
6. Electron spike
7. Capacitor die-away flow
8. Broken line boundary
9. Fuel reservoir
10. Pressure system
11. Simplex generator
12. Injector
13. Reaction chamber
14. Capacitor tuyere
15. Strakes
16. Toroidal capacitor bank
17. High pressure water spray
18. Bus-bar
19. Load cable
20. Gear
21. Gear motor
22. Reduction gearing set
23. Check valve
24. Live steam
25. Cooling air
26. Piston
27. Cam
28. Chamber
29. Motor shaft
30. Non-filling notch bearing
31. Spring
32. Electric heaters
33. Multiplex Generator

What is claimed is:

1. A fluidized alkaline metal, said fluidized alkaline metal used as an electrolytic fuel to transmit and store electrons for use in the operation of electrical transformers and electrical motors, a fuel reservoir to store said electrolytic fuel, a pressure system used to transfer said fluidized alkaline metal to a simplex generator, said simplex generator comprising a block, a spindle shaft rotatively mounted in said block, an aligned passage passing through said block and said rotatively mounted shaft, said aligned passage receiving the flow of fluidized alkaline metal from the said pressure system, aligned passage through said block and said rotatively mounted spindle shaft directs flow of said fluidized metal into an injector, a water spray in injector, said fluidized metal and said water spray passing into a reaction chamber and mixed with live steam, said fluidized alkaline metals chemically reacting with the said water and live steam in said reaction chamber is dissociated into charged ions, protons and electrons, said charged ions, protons and electrons pass into a capacitor tuyere, said electrons gathered at strake points mounted in the chamber of said capacitor tuyere, said strakes in communication with said tuyere capacitors which transmit the said electrons to a bus-bar, said bus-bar transmits said electrons to a load cable.

2. The fluidized alkaline metal of claim 1 is sodium.

3. The fluidized alkaline metal of claim 1 is a mixture of sodium and potassium.

4. The fluidized alkaline metal of claim 1 is a mixture of sodium, potassium and calcium.
